(19) United States
(12) Patent Application Publication
(10) Pub. No.: US 2002/0140193 A1
(43) Pub. Date: Oct. 3, 2002

(54) FOLDING AND LOCKING ARRANGEMENT FOR COLLAPSIBLE SCOOTER

(76) Inventor: Kao Teh Chai, Tao Yuan Hsien (TW)

Correspondence Address: Keith Kline, PRO-TECHTOR INTERNATIONAL SERVICES, 20775 Norada Court, Saratoga, CA, 95070-3018, US

(21) Appl. No.: 09/819,482

(22) Filed: Mar. 27, 2001

(51) Int. Cl. B62M 1/00

(52) U.S. Cl. 280/87.041; 280/639

(57) ABSTRACT

A folding and locking arrangement for a collapsible scooter mainly includes a folding bend, a bend holder fixedly mounted on a deck of the scooter, two stop pins having an expanded head, and a quick-release screw having a cam lever connected to a head thereof. The folding bend is fixedly connected to a handlebar of the scooter and has an arm portion pivotally connected to the bend holder. The bend holder includes two upright plates on which two arcuate guiding slots are provided. The two stop pins are extended through the guiding slots and the arm portion, so that the folding bend pivotally turns when the two stop pins move in the guiding slots. The quick-release screw is extended through the two stop pins and a spring disposed between the stop pins, such that when the cam lever is pulled outward, the two stop pins is pushed outward by the spring to freely move to either end of the guiding slots and bring the folding bend to a folded or an extended position. And, when the cam lever is pushed inward, the stop pins at either end of the guiding slots are pushed inward to firmly locate their expanded head in recesses surrounding the ends of the guiding slots and thereby lock the folding bend to the folded or the extended position.

### FIELD OF THE INVENTION

The present invention relates a folding and locking arrangement for a collapsible scooter, and more particularly to a folding and locking arrangement that enables easy and safe locking of a collapsible scooter in a fully folded or extended state.

### BACKGROUND OF THE INVENTION

In a conventional folding arrangement for a collapsible scooter as shown in FIG. 1, there is a connecting bracket 20 welded to a front end of a deck 10 of the scooter, a connecting stem 40 fixedly connected at an upper end to a handlebar 30 of the scooter and pivotally connected at a lower end to the connecting bracket 20 with a shaft 50, a stop pin 60 sideward projected from the connecting stem 40 to extend through an arcuate guiding slot 70 on the connecting bracket 20, and a tension spring 80 mounted between the shaft 50 and the stop pin 60 to normally pull the stop pin 60 into one of two stop recesses 90 provided at two ends of the guiding slot 70. When the stop pin 60 is shifted out of the stop recess 90 at a front end of the guiding slot 90, the handlebar 30 of the scooter can be folded toward the deck 10 while the stop pin 60 slides along the arcuate guiding slot 90. When the handlebar 30 is moved into a fully folded position on the deck 10, the stop pin 60 is pulled by the tension spring 80 into the other stop recess 90 at a rear end of the guiding slot 90 to lock the handlebar 30 in the folded position. By shifting the stop pin 60 from the rear stop recess 90 to the front stop recess 90, the folded handlebar 30 can be moved into a fully extended position.

In the above-described collapsible scooter and the folding arrangement thereof, a handlebar stem 100 of the scooter tends to rotate and loosen from the connecting stem 40, and the connecting bracket 20 welded to the deck 10 is subject to deformation due to frequent pull from the handlebar 30. These conditions would result in an unbalanced scooter due to an increased tolerance of rear wheel center thereof and accordingly endanger a rider of the scooter.

### SUMMARY OF THE INVENTION

It is therefore a primary object of the present invention to provide a folding and locking arrangement for a collapsible scooter to enable easy and safe locking of the scooter separately in fully folded or extended state without causing safety problems in riding the scooter.

The folding and locking arrangement for a collapsible scooter of the present invention mainly includes a folding bend, a bend holder fixedly mounted on a deck of the scooter, two stop pins having an expanded head, and a quick-release screw having a cam lever connected to a head thereof. The folding bend is fixedly connected to a handlebar of the scooter and has an arm portion pivotally connected to the bend holder. The bend holder includes two upright plates on which two arcuate guiding slots are provided. The two stop pins are extended through the guiding slots and the arm portion, so that the folding bend pivotally turns when the two stop pins move in the guiding slots. The quick-release screw is extended through the two stop pins and a spring disposed between the stop pins, such that when the cam lever is pulled outward, the two stop pins is pushed outward by the spring to freely move to either end of the guiding slots and bring the folding bend to a folded or an extended position. And, when the cam lever is pushed inward, the stop pins at either end of the guiding slots are pushed inward to firmly locate their expanded head in recesses surrounding the ends of the guiding slots and thereby lock the folding bend to the folded or the extended position.

The folding and locking arrangement for a collapsible scooter according to the present invention also includes two safety elements that are two frames having a shape corresponding to the arcuate guiding slots and being slightly smaller than the guiding slots. The two safety elements are mounted over the guiding slots to protect a rider's fingers from being pinched in the guiding slots, making the folding and locking arrangement safer for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a collapsible scooter with a conventional folding and locking arrangement;

FIG. 2 is an exploded perspective of a folding and locking arrangement for a collapsible scooter according to the present invention;

FIG. 3 is an assembled sectional view of the folding and locking arrangement of FIG. 2 in a released state;

FIG. 4 is an assembled sectional view of the folding and locking arrangement of FIG. 2 in a locked state;

FIG. 5 is a collapsible scooter having the folding and locking arrangement of the present invention, wherein the scooter is in an extended state;

FIG. 6 is a collapsible scooter having the folding and locking arrangement of the present invention, wherein the scooter is in a folded state; and

FIG. 7 is an assembled sectional view of the folding and locking arrangement of the present invention with safety elements added thereto.

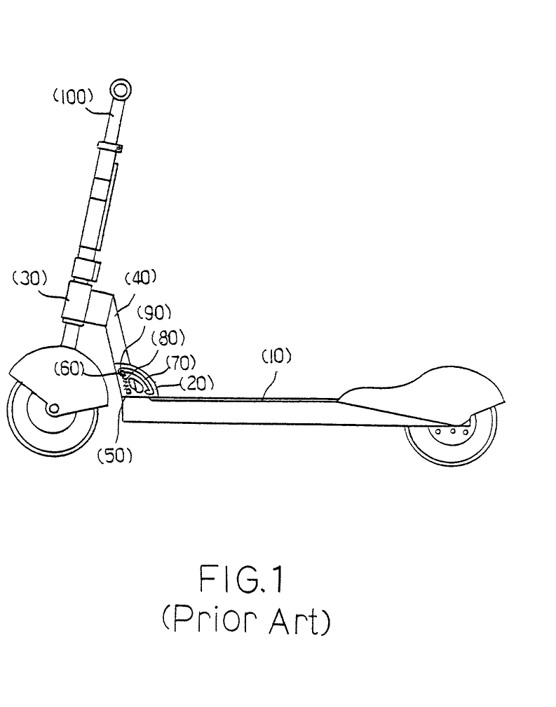

### DETAILED DESCRIPTION OF THE PREFERRED EMBODIMENTS

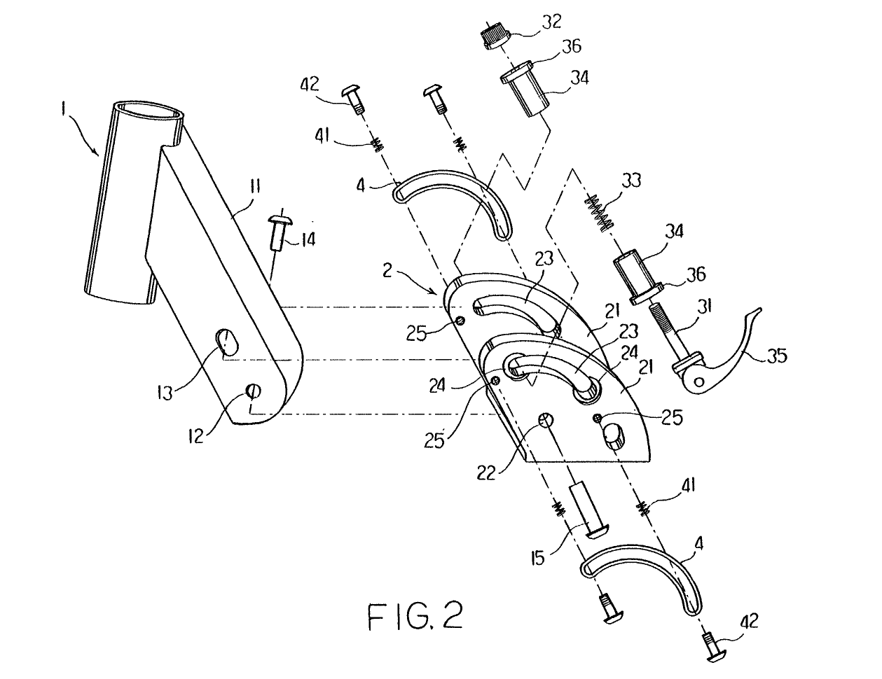

Please refer to FIG. 2 that is an exploded perspective of a folding and locking arrangement for a collapsible scooter according to the present invention. As shown, the arrangement mainly includes a folding bend 1 connected to a handlebar of the scooter, a bend holder 2 fixedly mounted on a deck 10 of the scooter, and a locking set 3.

The folding bend 1 includes a downward inclined arm portion 11 that may be a square tube or a tube of other shape. A pivot-screw hole 12 and a through hole 13 are separately provided near a lower end of the inclined arm portion 11.

The bend holder 2 includes a pair of upright plates 21, on each of which there is provided a pivot-screw hole 22 and an arcuate guiding slot 23 respectively corresponding to the pivot-screw hole 12 and the through hole 13 on the arm portion 11 of the folding bend 1. Areas on an outer side of each plate 21 closely surrounding two ends of the arcuate guiding slot 23 are cut away to provide two curved recesses 24.

The locking set 3 includes a quick-release screw 31 having a cam lever 35 connected to a head thereof, a nut 32, a spring 33, and two hollow stop pins 34 each having an expanded head 36.

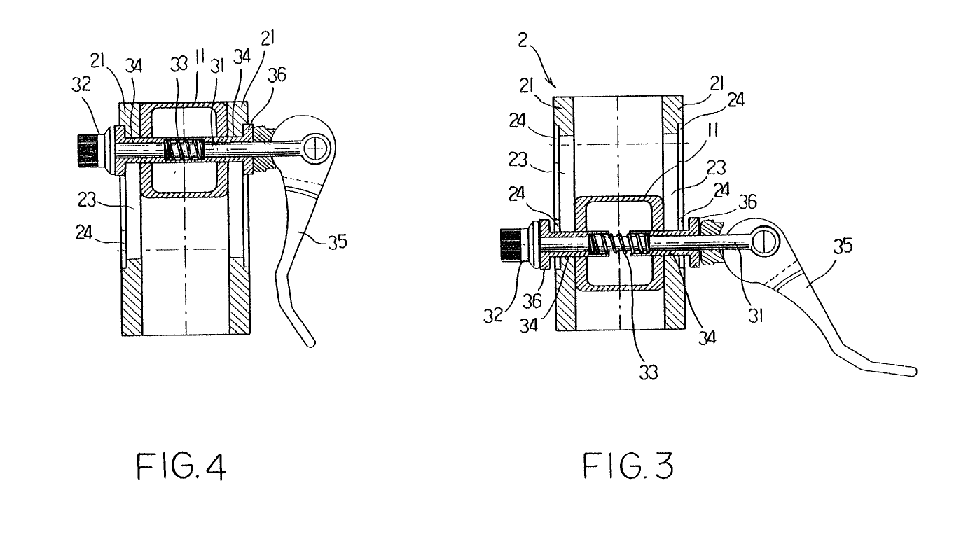

Please refer to FIG. 3. The arm portion 11 of the folding bend 1 is pivotally connected to and between the two upright plates 21 of the bend holder 2 by extending two screws or cap screws 14, 15 in two opposite directions through the pivot-screw holes 22 and 12 on the plates 21 and the arm portion 11, respectively. The two hollow stop pins 34 of the locking set 3 are separately extended from outer sides of the two plates 21 through the arcuate guiding slots 23 and into the through hole 13 on the arm portion 11 to face each other. The spring 33 is disposed in the two hollow stop pins 34 to normally push them outward. The quick-release screw 31 is extended from one of the two plates 21 through the two hollow stop pins 34 and the spring 33 to engage with the nut 32 at the other plate 21.

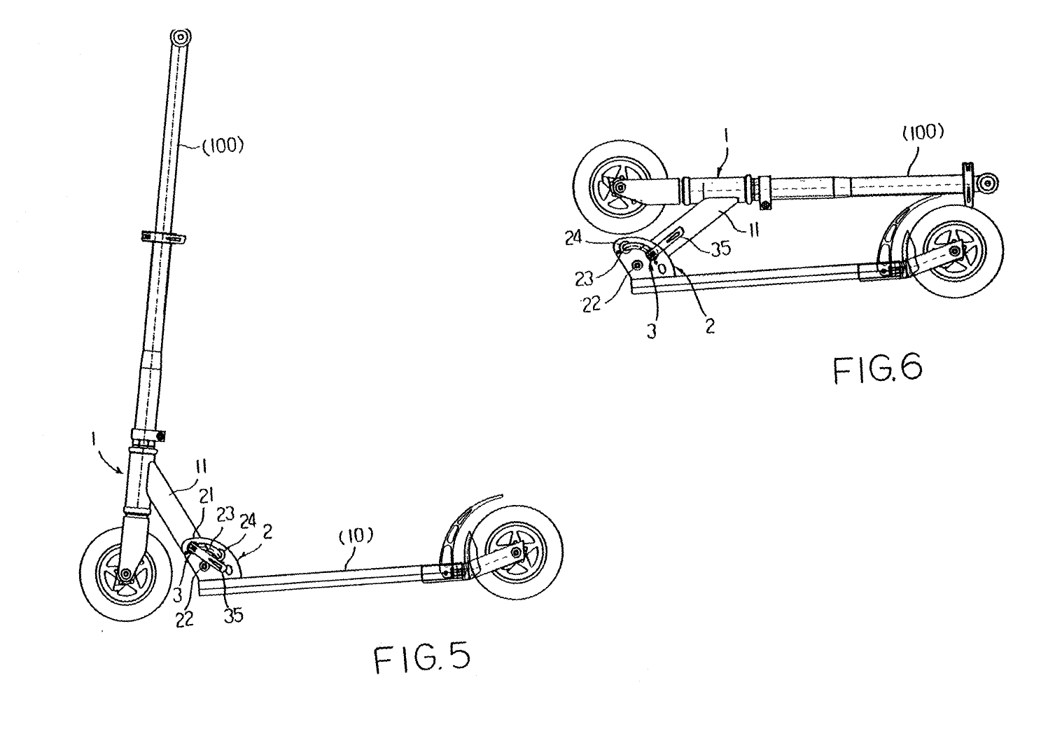

When the cam lever 35 connected to the head of the quick-release screw 31 is pulled outward, the two stop pins 34 are pushed outward by the spring 33 into a released position, so that the expanded head 36 of the stop pins 34 do not contact with the two upright plates 21, as shown in FIG. 3. The two stop pins 34 in the released position could be moved in the arcuate guiding slots 23 from an end to the other end of the guiding slots 23, allowing the folding bend 1 to pivotally turn about the screws 14, 15. When the stop pins 34 are moved to a front ends of the guiding slots 23 and the cam lever 35 is pushed inward, the two stop pins 34 are pressed toward each other to bring the expanded heads 36 into the two curved recesses 24 and tightly press against the same, as shown in FIG. 4. At this point, the two stop pins 34 are in a locked position and the folding bend 1 is firmly locked to an extended position relative to the deck 10 of the scooter. On the other hand, when the two released stop pins 34 are shifted along the guiding slots 23 to pivotally turn the arm portion 11 of the folding bend 1 to the rear end of the guiding slots 23 and the cam lever 35 is pushed inward, the expanded heads 36 of the two stop pins 34 are moved into the two curved recesses 24 at the rear end of the two guiding slots 23 and tightly pressed against the recesses 24, firmly locking the folding bend 1 to a folded position. The stop pins 34 in the locked position securely and stably lock the folding bend 1 to the folded or the extended position without the risk of an accidentally loosened folding bend 1 from the bend holder 3. FIGS. 5 and 6 show the folding bend 1 is locked to the extended and the folded positions, respectively, so that the scooter could be used and stored, respectively.

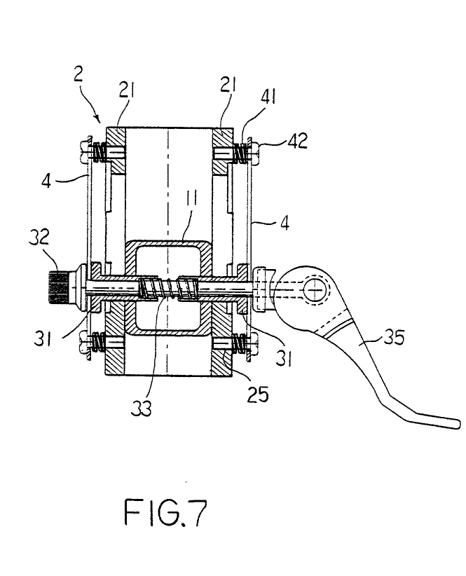

Please refer to FIGS. 2 and 7 at the same time. The two upright plates 21 of the bend holder 2 are optionally provided with two pairs of screw holes 25 at predetermined positions for two safety elements 4 to connect to outer surfaces of the two plates 21 over the arcuate guiding slots 23. The safety element 4 is a frame having a shape corresponding to the arcuate guiding slot 23 and an inner dimensions slightly smaller than that of the guiding slot 23. The safety element 4 is mounted onto the plate 21 by threading screws 42 through two ends of the safety element 4 and two elastic elements 41, such as springs, into the pair of screw holes 25. In the case there are safety elements 4 mounted on the plates 21, the quick-release screw 31 is first extended through one of the safety elements 4 and then the stop pins 34 to engage with the nut 32 at outer side of the other safety element 4. Since the safety elements 4 have inner dimensions smaller than the arcuate guiding slots 23, they effectively protect a rider's fingers from being pinched in the guiding slots 23.

The springs 41 act to normally push the safety elements 4 away from the guiding slots 23 by a safe distance. Other materials such as rubber pads and other elastic materials may be used to replace the springs 41.

In brief, the folding and locking arrangement for a collapsible scooter according to the present invention is characterized in the two curved recesses provided on the two upright plates of the bend holder around front and rear ends of the arcuate guiding slots. When the cam lever is pulled, the two stop pins are released from the curved recesses at one end of the guiding slots and could be moved to the other end of the guiding slots to fold or extend the folding bend to or from the deck of the scooter. Thereafter, the cam lever is pushed to press the two stop pins tightly against the curved recesses and firmly lock the folding bend in the folded or extended position. The operation of the cam lever is simple and convenient and does not produce any noise or vibration. The provision of the safety elements over the arcuate guiding slots protects the rider's fingers from being pinched in the slots, allowing the scooter to be used in a safer manner.

What is claimed is:

1. A folding and locking arrangement for a collapsible scooter, comprising a folding bend connected to a handlebar of said scooter, a bend holder fixedly mounted on a deck of said scooter, and a locking set;
said folding bend including an inclined arm portion that downward extends toward the deck of said scooter and is provided near a lower end with a pivot-screw hole and a through hole;
said bend holder including two upright plates being provided with a pivot-screw hole and an arcuate guiding slot respectively corresponding to said pivot-screw hole and said through hole on said arm portion of said folding bend, areas on an outer side of each said upright plate closely surrounding two ends of said arcuate guiding slot being cut away to provide two curved recesses, and said arm portion of said folding bend being pivotally mounted to and between said two upright plates by extending pivot screws through said pivot-screw holes on said upright plates and said arm portion;
said locking set including a quick-release screw having a cam lever connected to a head thereof, a nut, a spring, and two hollow stop pins each having an expanded head; said two hollow stop pins being separately extended from outer sides of said two upright plates through said arcuate guiding slots and into said through hole on said arm portion to face each other, said spring being disposed in said two hollow stop pins to normally push them outward, an end of said quick-release screw opposite to said cam lever being extended through said two hollow stop pins and said spring to engage with said nut;
said stop pins being pushed outward by said spring and movable in said arcuate guiding slots to bring said folding bend to pivotally turn about said pivot screws to a folded or an extended position when said cam lever is pulled outward; and said stop pins moved to either end of said arcuate guiding slots being pushed inward to locate said expanded heads in said curved recesses to tightly press against said recesses when said cam lever is pushed inward, so that said folding bend is firmly locked to said folded or said extended position.

2. The folding and locking arrangement for a collapsible scooter as claimed in claim 1, further comprising two safety elements that are two frames having a shape corresponding to said arcuate guiding slot and being slightly smaller than said guiding slot, each of said safety elements being mounted onto said upright plate over said guiding slot by threading screws through two ends of said safety element and two elastic elements into screw holes provided on said upright plate, so as to protect a rider's fingers from being pinched in said guiding slots.
